(19) United States
(12) Patent Application Publication
(10) Pub. No.: US 2004/0140881 A1
(43) Pub. Date: Jul. 22, 2004

(54) Adjusting device for a thermal trip

(76) Inventors: Wolfgang Leitl, Wenzenbach (DE); Christoph Weber, Ergoldsbach (DE)

Correspondence Address: HARNESS, DICKEY & PIERCE, P.L.C., P.O.BOX 8910, RESTON, VA, 20195, US

(21) Appl. No.: 10/477,700

(22) PCT Filed: Jun. 19, 2002
(86) PCT No.: PCT/DE02/02223

(30) Foreign Application Priority Data
Jul. 2, 2001 (DE) 10131963.0
Oct. 15, 2001 (DE) 20116792.1

(51) Int. Cl. H01H 61/00

(52) U.S. Cl. 337/57

(57) ABSTRACT

The invention relates to an adjusting device for a thermal trip of a switchgear (1), comprising a bimetal (3), which is held in a fixed manner on a bimetal support (4), whose free end (3b) is located at a distance from a tripping lever (6), and which increasingly acts upon this tripping lever in a tripping direction (D) as a result of thermal deformation. According to the invention, the distance (A) can be adjusted by deforming the bimetal support (4). The adjusting device is particularly suited for use in circuit breakers or the like.

The invention relates to an adjustment apparatus for a thermal release for a switching device, having a bimetallic strip which is held in a fixed position on a bimetallic strip mount. In this case, the expression switching device means mechanical or electromechanical switching devices, in particular line circuit breakers, power breakers, relays, contactors or the like.

A switching device such as this is used for connecting a circuit to a power supply system and for manual and automatic disconnection of the circuit from the power supply system when the current exceeds a predetermined value. Thus, for example, a line circuit breaker is used for protecting lines in installations and systems from overloading and short-circuits. In a power supply system in which disconnection is provided by overcurrent protective devices, a switching device such as this additionally prevents the existence of high direct contact voltages in the event of a fault.

When the switching device or circuit breaker is switched on, an energy store, for example a spring, is loaded as part of a mechanical switching mechanism, and this energy is released during the tripping process, and operates the switch. In this case, the switching device has a thermal release in the form of a conventional bimetallic strip, which trips with a delay as a function of the overload time. The tripping process is initiated by thermal deformation of the bimetallic strip as a result of an overcurrent being passed through it.

This is done by a tripping lever, which is opposite the free end of the bimetallic strip, is at a distance from it, and is mechanically coupled to the switching mechanism, being acted on by the bimetallic strip. Thus, via this, the bimetallic strip unlatches the switching mechanism, while the energy store of the switching mechanism opens a moving contact, by lifting the latter off a fixed contact. Furthermore, the switching device normally additionally has a magnetic or electromagnetic release, which trips without any delay, for high surge currents and short-circuit currents.

The distance between the free end of the bimetallic strip and the tripping lever can be designed to be adjustable, and an adjusting screw is normally provided for this purpose. Switching devices in which an adjusting screw such as this is used to adjust the bimetallic strip are known, for example, from DE 1 904 731 A1, from EP 0 143 981 A1 and from EP 0 412 953 A3. However, the use of an adjusting screw is associated with corresponding production and manufacturing costs.

The invention is thus based on the object of specifying a particularly cost-effective adjustment apparatus, which can be adjusted easily, for a switching device, in particular for a line circuit breaker.

According to the invention, this object is achieved by the features of claim 1; advantageous refinements of the invention are the subject matter of the respective dependent claims.

The advantages which are achieved by the invention are, in particular, that, by suitable configuration and arrangement of a bimetallic strip mount to which the bimetallic strip is fitted, this bimetallic strip mount is deliberately deformed, thus making it possible to provide a simple and cost-effective adjustment apparatus, which if required is self-adjusting, for a thermal release for a switching device. The distance between the free end of the bimetallic strip and the tripping lever can in this case be set or adjusted on the one hand by deformation, in particular by twisting, and if necessary by means of a tool for the handling or holding limb, and on the other hand can be maintained by automatic bending of the bimetallic strip mount when the housing shrinks as a result of ageing.

In one advantageous refinement, the bimetallic strip mount has a holding limb, which runs parallel to the bimetallic strip, is connected to its contact end and has a fixing end as a fixed attachment point. This holding limb, which is preferably curved in the form of a step, is adjacent on one side to a handling limb, which acts as an adjustment area, and on the other side via a bend to an at least approximately U-shaped fixing limb of the bimetallic strip mount. The stepped contour of the holding limb makes it possible to hold bimetallic strips of different length, in particular also including bimetallic strips which can be heated indirectly, by means of the same bimetallic strip mount. This makes it possible to considerably reduce the number of different thermal releases which have to be provided or kept available for different types of switching device and, in particular, to keep this number small overall.

The setting of the distance between the bimetallic strip and the tripping lever and hence the adjustment of the thermal release are expediently carried out by twisting the handling limb, which runs transversely with respect to the holding limb and acts as an adjustment area for the bimetallic strip mount. For this purpose, the handling limb is advantageously in the form of a perforated plate. In this case, a number of through-openings, preferably in the form of round holes, are incorporated in the handling limb.

The handling limb of the bimetallic strip mount can be fixed in position in a housing opening or contour whose position is fixed and which also acts as an opening for rotation. For this purpose, the handling limb is expediently positioned in the area of the free end of the bimetallic strip. Alternatively, the bimetallic strip mount may be shaped like a loop, with the handling limb then being supported at the end on the bimetallic strip mount. In this embodiment, a desired bending point is preferably provided in the area of the loop apex of the bimetallic strip mount.

This mechanism, which is used to adjust the bimetallic strip and in which the bimetallic strip mount which holds the bimetallic strip is mounted via two attachment points such that it is fixed to the housing, of which attachment points one fixed attachment point ensures that the bimetallic strip—and hence the thermal release—is mounted such that it is stable, and the other attachment point comprises the adjustment means for adjustment of the bimetallic strip by deformation, allows the thermal release to be adjusted finely and exactly.

The switching device has a housing which is formed from urea and/or melamine resin molding compound. The urea or melamine resins, which are included in the family of thermosetting plastics, are particularly suitable for cost-reducing production of mass-produced items and batch-produced items.

Exemplary embodiments of the invention will be explained in more detail in the following text with reference to a drawing, in which:

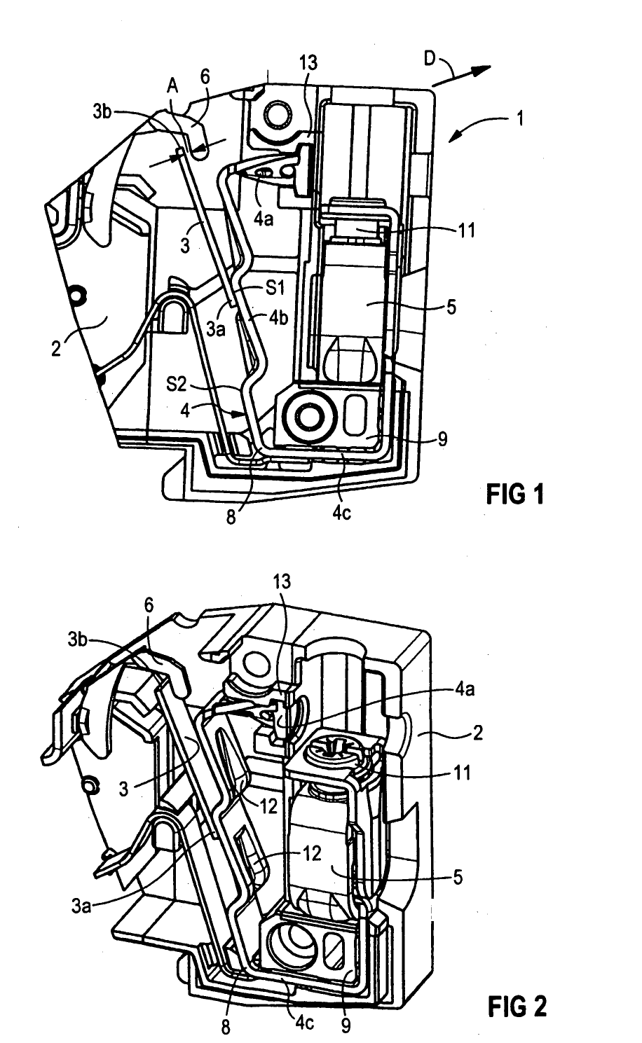

FIGS. 1 and 2 show, respectively, in the form of a plan view and a perspective illustration, a thermal release which is finally mounted in a switching device and has an adjustment apparatus with a bimetallic strip mount that can be twisted and has a short bimetallic strip,

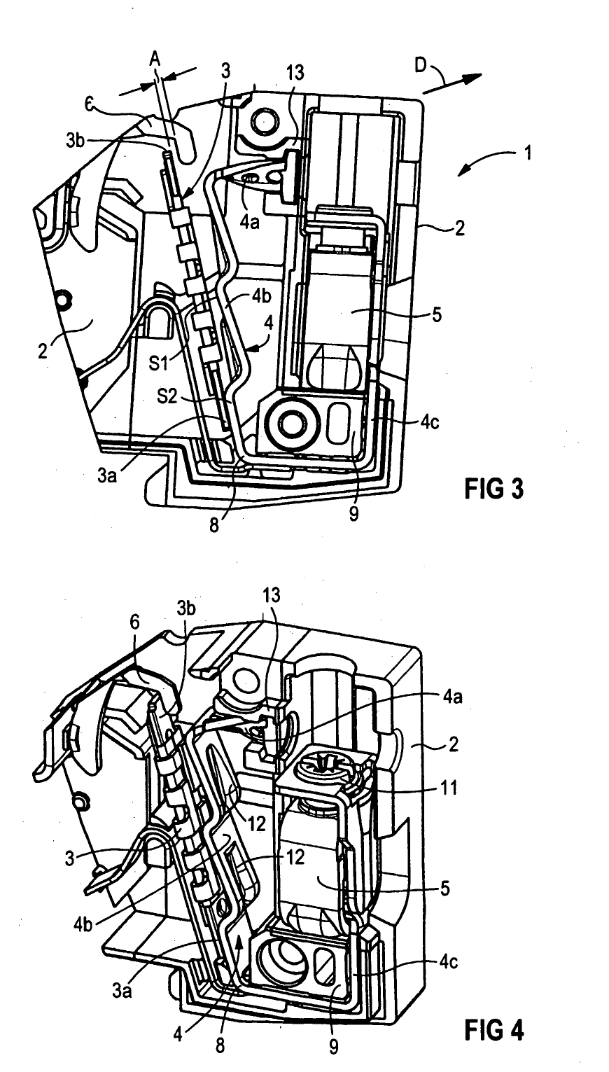

FIGS. 3 and 4 show, in illustrations corresponding to FIGS. 1 and 2 respectively, the adjustment apparatus with a long bimetallic strip,

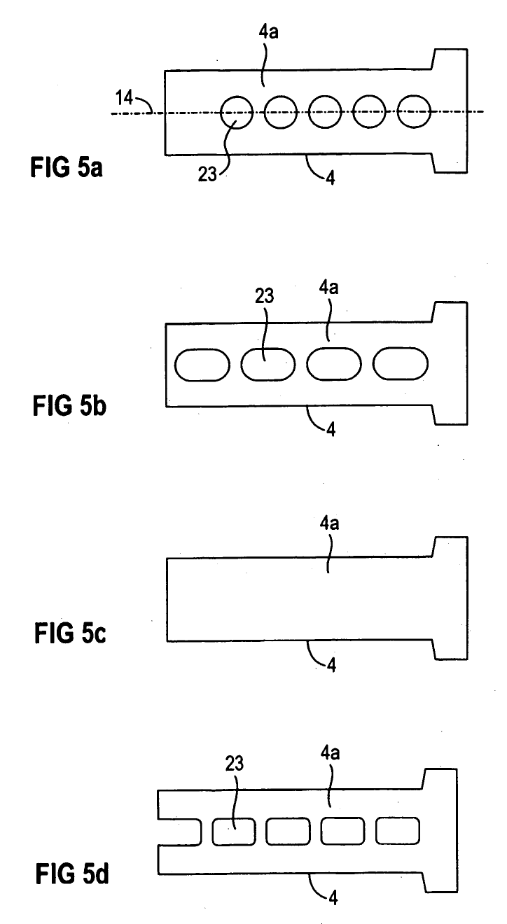

FIGS. 5a to 5d show different geometries of a handling limb of the adjustment apparatus as shown in FIGS. 1 to 4,

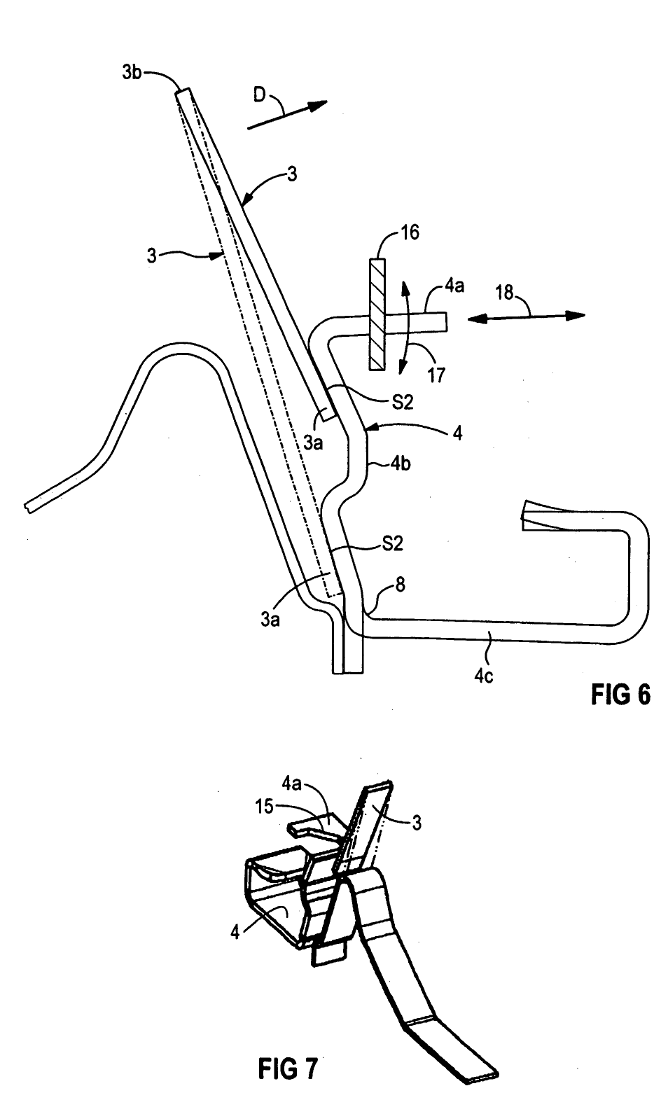

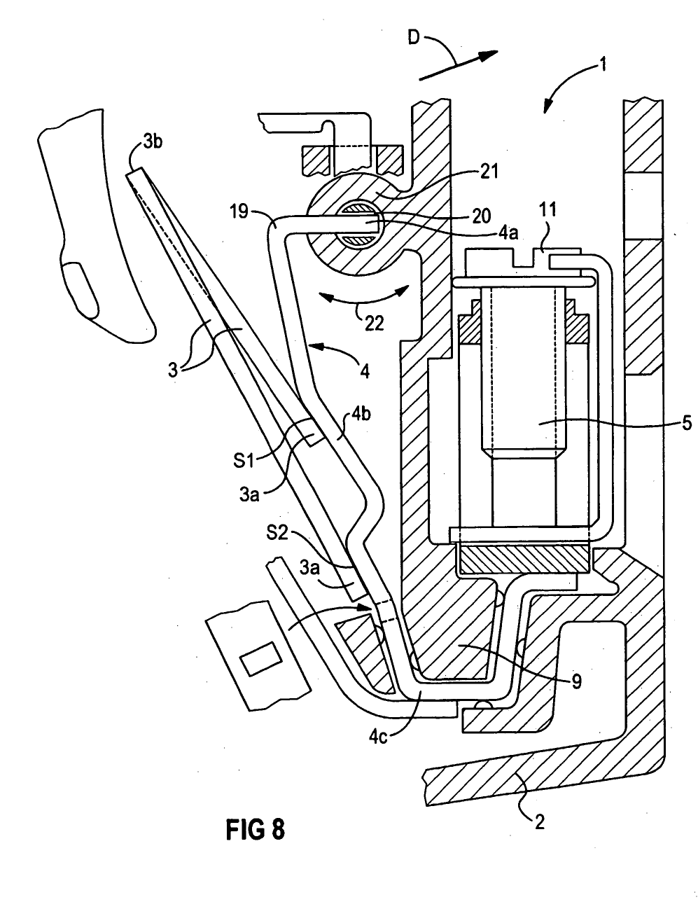

FIGS. 6 and 7 show, respectively, a side view and a perspective illustration of an adjustment apparatus with a bimetallic strip mount which can be deformed in an alternative manner,

FIGS. 8 to 11 show section illustrations of various variants of the deformation mechanism of the adjustment apparatus, and

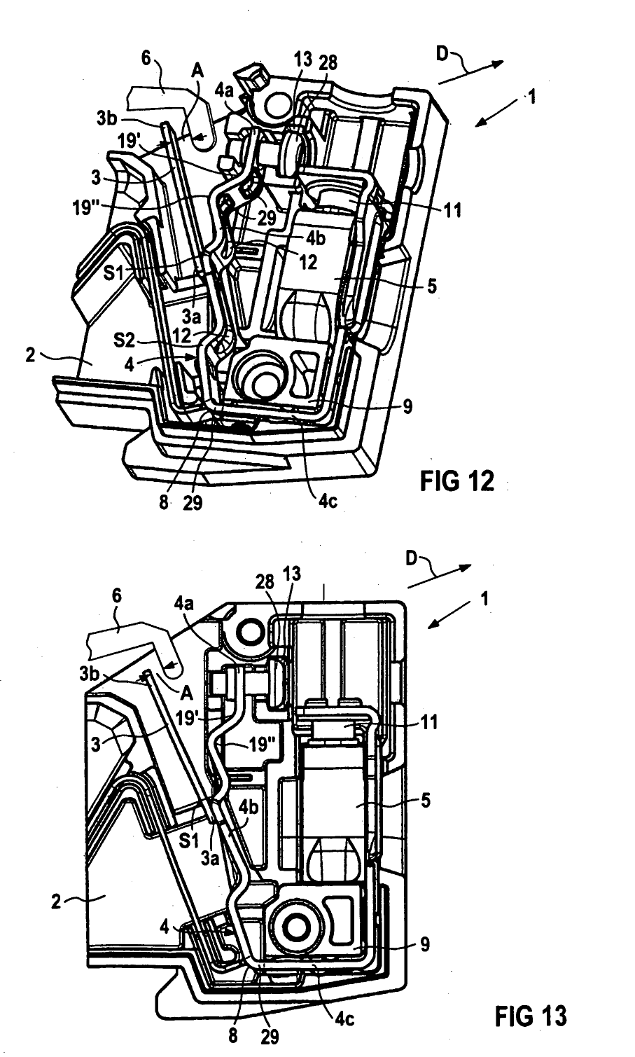

FIGS. 12 and 13 show, respectively, in the form of a plan view and a perspective illustration a thermal release, which is finally mounted in a switching device, with a further adjustment apparatus having an adjustment means for the bimetallic strip mount with a short bimetallic strip.

Parts which correspond to one another are provided with the same reference symbols in all the figures.

FIGS. 1 to 4 show, in the form of details, a switching device 1 with the housing cover of its housing 2 lifted off, in which the essential parts of an adjustable thermal release are shown such that they are visible. The thermal release has a bimetallic strip 3, whose contact end 3a is connected by techniques such as bonding, soldering or welding to a bimetallic strip mount 4, and is thus held in a fixed position. The bimetallic strip mount 4 is electrically conductively connected via the switching device 1 to a connecting terminal 5, in order to supply power.

The free end 3b of the bimetallic strip 3, that is to say the tip of the bimetallic strip, is opposite and at a distance from a tripping lever 6, which is coupled in a manner known per se to a switching mechanism, which is not illustrated in any more detail. This distance A between the tip of the bimetallic strip 3b and the tripping lever 6 can be adjusted by bending or deformation of the bimetallic strip mount 4.

The bimetallic strip mount 4 is shaped such that it has two or more bends or curves, and is additionally in the form of a step. In this case, a bimetallic strip 3 can be fixed by its contact end 3a on each step S1, S2, and thus in different positions or at different connecting points on the bimetallic strip mount 4. This means that both a short bimetallic strip 3 as shown in FIGS. 1 and 2 and a comparatively long bimetallic strip 3 as shown in FIGS. 3 and 4, which may be designed such that it can be heated indirectly, can be fixed or fitted to the same bimetallic strip mount 3. The thermal release can thus be configured for different current levels, with optimum material savings.

The bimetallic strip mount 4 has a handling limb 4a and a holding limb 4b, which runs transversely with respect to it, that is to say it runs at least approximately at right angles. The contact end 3a of the bimetallic strip 3 is connected to this holding limb 4b by techniques such as bonding, soldering or brazing. The holding limb 4b merges at a bend point 8 into a fixing limb 4c, which is itself curved to be approximately U-shaped.

The bimetallic strip mount 4 is fixed in position by this fixing limb 4c in the housing 2 by means of corresponding housing fittings or contours 9, and is fixed in place clamped by means of a connecting screw 11. In this case, at least a part of the limb length of the holding limb 4b is inserted in the housing 2, without touching it. Beads 12 are incorporated in the holding limb 4b in the area of the steps S1 and S2, so that a relatively thin sheet-metal material can be used for the bimetallic strip mount 4, with high dimensional stability and adequate load-bearing stiffness.

The handling limb 4a (which is located in the area of the free end 3b of the bimetallic strip 3 where it points outwards) of the bimetallic strip mount 4 is held at the end in a housing opening or contour 13, where it is supported. The handling limb 4a is designed such that it can be deformed. In this case, the handling limb 4a of the bimetallic strip mount 4 is twisted by means of a handling tool (which is not illustrated) in order to adjust the bimetallic strip and thus to set the distance A between the free end 3b of the bimetallic strip 3 and the tripping lever 6, so that the bimetallic strip mount 4 is bent or deformed.

In consequence, the position of the bimetallic strip 3 is varied appropriately in order to adjust the distance A.

The twisting of the handling limb 4a thus results in rotation of the bimetallic strip 3 and thus of its free end or bimetallic strip tip 3b in the tripping direction D. The adjustment apparatus is in this case essentially formed by the fixed-position handling limb 4b of the bimetallic strip mount 4, with the bimetallic strip 3 held on it.

FIGS. 5a to 5d show different geometries of the handling limb 4a of the bimetallic strip mount 4.

While, in principle, this T-shaped handling limb 4a as shown in FIG. 5c can be formed from solid material, through-openings 23 are expediently incorporated along the limb longitudinal axis 14 in the handling limb 4a, and thus in the adjustment area of the bimetallic strip mount 4. As is shown in FIGS. 5b and 5d, these through-openings 23 may be in the form of elongated holes or rectangular openings. However, a number of circular holes 23 as shown in FIG. 5a are advantageous. This is because this geometry makes it possible to achieve a particularly advantageous ratio between the rotation angle and the change in the length of the handling limb 4a. This results in the desired aim to a particularly high degree of allowing fine and accurate adjustment with a comparatively large rotation angle and a small change in length.

In the embodiment of the adjustment apparatus illustrated in FIGS. 6 and 7, the handling limb 4a is provided with a tab-like contour 15, which can be guided along a curved opposing contour 16, which is fixed to the housing and whose position is thus fixed. In this embodiment, the adjustment and hence the setting of the distance A are carried out by bending the handling limb 4a in the direction of the arrow 17. In the process, as it slides along the curved fixed-position opposing contour 16 over the tab-like contour 15, the handling limb 4a is moved in the direction of the arrow 18, so that the bimetallic strip tip 3b is in turn moved in the tripping direction D. The length of the movement path (as symbolized by the arrow 17) of the handling limb 4a in this case depends on the gradient of the curved, fixed-position opposing contour 16.

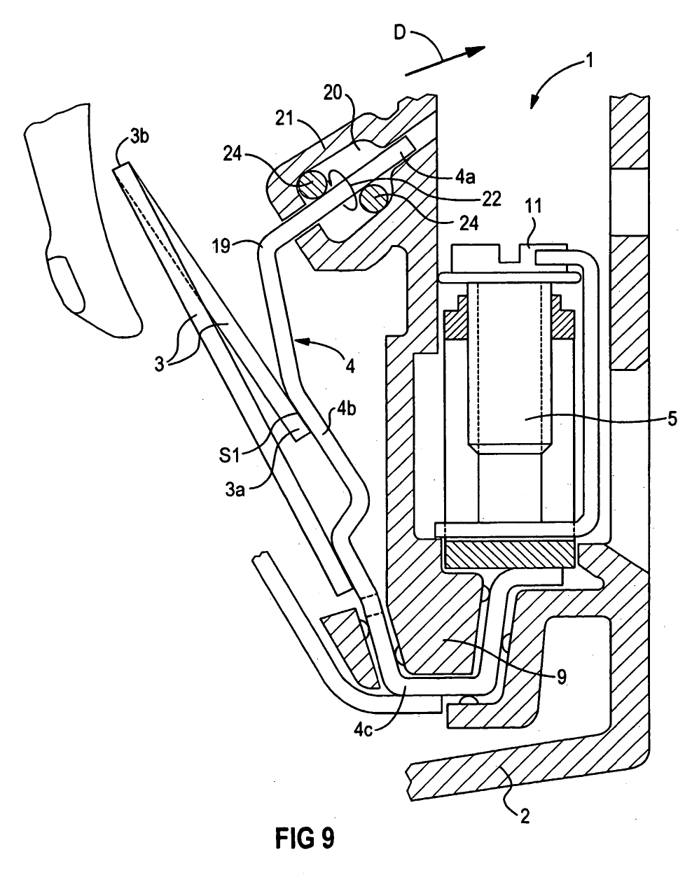

In the embodiment of the bimetallic strip mount 4 illustrated in FIGS. 8 and 9, the handling limb 4a is once again bent inwards and, in the process, is once again bent to form a first kinking/bending point 19′. The kinking/bending point 19′ is—in the same way as the bending point 8—formed by a hole or a stamped region in the sheet-metal material of the bimetallic strip mount 4. At the free end, the handling limb 4a is passed into a housing receptacle or rotating opening 20, which acts as a rotating contour and is provided in a correspondingly positioned housing contour, expediently in the form of a dome-shaped housing fitting 21. The operating tool for adjustment of the bimetallic strip acts on this free end of the handling limb 4a, which is located within the rotating opening 20.

In this embodiment, rotation or twisting of the handling limb 4a in the direction of the illustrated double-headed arrow 22 once again results in the bimetallic strip mount 4 being bent or twisted, and in the position of the bimetallic strip 3 being varied in order to adjust the distance A. In this case, in the embodiment illustrated in FIG. 8, the handling limb 4a is rotated as rolling it up about an axis running at right angles to the plane of the drawing.

In the embodiment shown in FIG. 9, the handling limb 4a is twisted about its transverse limb axis. In the process, the handling limb 4a which is held or fixed in position in the area of the first kinking/bending point 19, and at the free end can be rotated or twisted by means of a rotation or handling tool 24, in the form of a fork, which for this purpose is inserted into the rotating or adjustment opening 20, and is rotated in the direction of the arrow 22. In this case as well, when the handling limb 4a is rotated in the direction of the illustrated arrow 22, the bimetallic strip tip or the free end 3b of the bimetallic strip 3 is once again rotated in the tripping direction D, thus resulting in the adjustment of the bimetallic strip. In this embodiment, the adjustment apparatus is formed essentially by the bimetallic strip mount 4 with the bimetallic strip 3 held on it, and the rotating opening 20′ in the housing attachment 21, which acts as an adjustment contour.

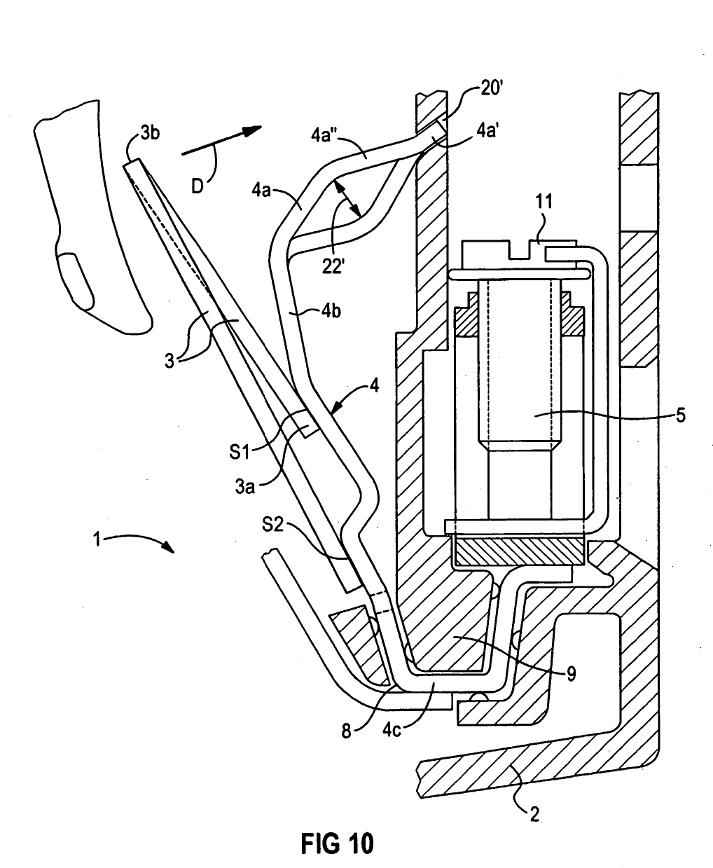

In the embodiment of the thermal release illustrated in FIG. 10, the bimetallic strip 3 is adjusted by a type of kinking bending movement of the handling limb 4a of the bimetallic strip mount 4 in the direction of the deformation arrow 22′. In this case, the free end 4a′ of the handling limb 4a is held in a housing opening 20′ so that the handling limb 4a can be bent out or in its central region 4a″. In this case as well, during deformation of the handling limb 4a in the direction of the illustrated arrow 22′, the bimetallic strip tip or the free end 3b of the bimetallic strip 3 is once again moved in the tripping direction D, thus resulting in adjustment of the bimetallic strip.

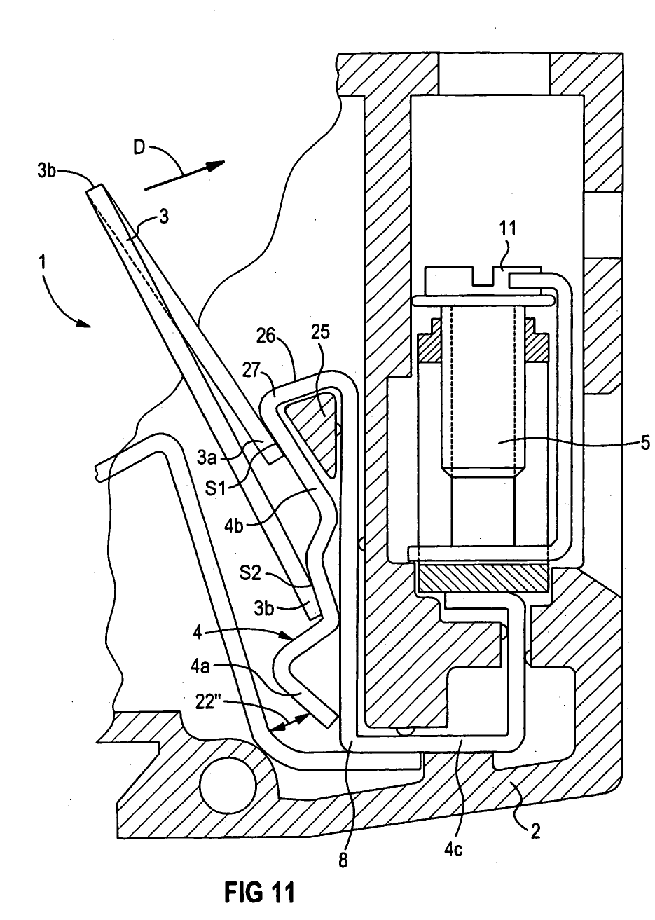

FIG. 11 furthermore shows an alternative embodiment, in which the holding limb 4b of the bimetallic strip mount 4 is guided around a housing contour 25, forming a loop. In this case, a desired bending point 27 is incorporated in the bimetallic strip mount 4, in the area of the loop apex 26 of the bimetallic strip mount 4. In this embodiment, the end of the handling limb 4a is located in the junction region between the holding limb 4b and the fixing limb 4c and in the process is located in the vicinity of the bending point 8 in the bimetallic strip mount 4, where it is supported. Rotation or bending of the handling limb 4a about the desired bending point 27 in the direction of the arrow 22″ once again results in the bimetallic strip tip or the free end 3b of the bimetallic strip 3 being rotated in the tripping direction D, thus adjusting the bimetallic strip.

FIGS. 12 and 13 show an alternative embodiment of the thermal release which differs on the one hand from the embodiment of the thermal release illustrated in FIGS. 1 and 2 by the use of an adjusting means 28 in the form of an adjusting screw or, as an alternative to this, in the form of a plug-in pin or the like, which latches in in steps. On the other hand, the handling limb 4a which can be adjusted by means of the adjusting means 28 is arranged to be very largely at right angles to it. Furthermore, the embodiment of the bimetallic strip mount 4 illustrated in FIGS. 12 and 13, and in contrast to the embodiment shown in FIGS. 1 and 2, is bent outwards at the first kinking/bending point 19′, with the assistance of a hole/stamped-out region 29, which assists bending. The bimetallic strip mount 4 is bent adjacent to this, forming a second kinking/bending point 19″, which is perforated by the hole/stamped-out region 29.

The bending point 8 is formed in the same way as the kinking/bending points 19′, 19″.

In the further course of the bimetallic strip mount 4, beads 12 are likewise incorporated in the area of the steps S1 and S2 in the holding limb 4b, so that it is possible to use a relatively thin sheet-metal material for the bimetallic strip mount 4, while retaining a high degree of dimensional stability and adequate load-bearing stiffness. Beads 12 and bending and kinking/bending points 8 and 19′, 19″, respectively, which are provided with holes/stamped-out regions 29 can accordingly be incorporated deliberately depending on the desired method of operation, for example with partial stiffening and/or automatic readjustment in the form of an outward bend at desired bending points on the bimetallic strip mount 4.

In the embodiment illustrated in FIGS. 9 and 10 as well as 12 and 13, the mechanism which is used for adjustment of the bimetallic strip advantageously also compensates for material-specific subsequent housing shrinkage, which is in practice unavoidable. Typical materials are generally plastics, in particular thermosetting plastics or thermoplastics. A thermosetting plastic has in this case been found to provide particularly good thermal stability, with a thermoplastic being distinguished by a finer configuration capability. Thermosetting plastics, which are preferably used, are on the one hand urea resin molding compounds and, on the other hand, melamine resin molding compounds.

The reason for this is that, if the position of the tripping lever 6 changes in the direction of the free end 3b of the bimetallic strip 3 as a result of such subsequent shrinkage of housing, then this subsequent shrinkage of the housing—depending on the embodiment variant of the thermal release—also results in movement closer to the housing contours which act as an adjustment contour, and in or on which the bimetallic strip mount 4 partially rests. The force which is thus introduced to the bimetallic strip mount 4 results in automatic kinking and/or bending of the kinking/bending points 19′, 19″ and, possibly, of the bending point 8, such that the distance A remains constant. This makes it possible to avoid undesirable premature tripping of the thermal release. The readjustment behavior of the bimetallic strip mount 4 can be defined by deliberately changing the geometric relationship between the bending point 8 and the kinking/bending point 19′, 19″.

The ageing processes which may possibly occur as a result of heating or radiation influences when low-cost materials are used, and the material/housing shrinkages that occur as a result of them can thus advantageously be compensated for in a simple manner. The adjustment apparatus according to the invention results in a relatively large deformation movement with a relatively short change in length, at the same time, of the bimetallic strip mount 4 which can be deformed for adjustment. This allows particularly sensitive or fine adjustment of the bimetallic strip 3 for a thermal release. The adjustment apparatus is in this case also suitable for cold adjustment, with there being no need for any additional adjustment elements, for example in the form of a screw or the like. This makes it possible to save costs since the bimetallic strip mount 4 can also be manufactured on relatively simple tools.

Furthermore, low-cost materials and, in particular, bimetallic strips 3 of different lengths can be used, which in turn leads to considerable cost savings. This adjustment apparatus means that the actual adjustment process is reversible, at least within certain limits. Furthermore, the adjustment process can be carried out with the device housing 2 open or closed. Furthermore, the adjustment apparatus and hence the thermal release are particularly insensitive to shock loads, since the bimetallic strip 3 is at the same time mounted in a robust manner.

The invention as explained above can be summarized as follows:

In order to specify a particularly low-cost adjustment apparatus which can be adjusted easily for a thermal release for a switching device 1, in particular a line circuit breaker, the invention provides for the distance A between the tripping lever 6 and the free end 3b of the bimetallic strip 3 to be adjustable by deformation of the bimetallic strip mount 4 for the thermal release, with a bimetallic strip 3 which is held in a fixed position on a bimetallic strip mount 4, whose free end 3b is at a distance from a tripping lever 6 and acts on the latter increasingly in the tripping direction D as a result of thermal deformation.

1. An adjustment apparatus for a thermal release for a switching device (1), having a bimetallic strip (3) which is held in a fixed position on a bimetallic strip mount (4) and whose free end (3b) is at a distance from a tripping lever (6) and applies force to this tripping lever (6) increasingly in the tripping direction (D) as a result of thermal deformation of the free end (3b), with the distance (A) being adjustable by deformation of the bimetallic strip mount (4).

2. The adjustment apparatus as claimed in claim 1, in which the bimetallic strip mount (4) has a handling limb (4a) at the free end and has a holding limb (4b), which runs parallel to the bimetallic strip (3), is connected to its contact end (3a), and is curved in the form of a step.

3. The adjustment apparatus as claimed in claim 2, in which the distance (A) can be adjusted by manual deformation of the handling limb (4a) and/or of the holding limb (4b) of the bimetallic strip mount (4).

4. The adjustment apparatus as claimed in claim 2 or 3, in which the distance (A) can be adjusted by twisting the handling limb (4a), which runs transversely with respect to the holding limb (4b), and/or by bending the holding limb (4b).

5. The adjustment apparatus as claimed in one of claims 2 to 4, in which the handling limb (4a) and/or the holding limb (4b) are/is in the form of a perforated plate or perforated plates with a number of through-openings (23) which are arranged one behind the other in the limb longitudinal direction (14).

6. The adjustment apparatus as claimed in one of claims 1 to 3, in which the bimetallic strip mount (4) has an at least approximately U-shaped fixing limb (4c) which is adjacent to the holding limb (4b), via a bend (8).

7. The adjustment apparatus as claimed in one of claims 2 to 5, in which the handling limb (4a) of the bimetallic strip mount (4) is fixed in position in a fixed-position opening (13; 20).

8. The adjustment apparatus as claimed in one of claims 2 to 5 or 10, in which the handling limb (4a) is positioned in the area of the free end (3b) of the bimetallic strip (3).

9. The adjustment apparatus as claimed in one of claims 2 to 5, 7 or 8, in which the handling limb (4a) is supported on the bimetallic strip mount (4), which is shaped like a loop.

10. The adjustment apparatus as claimed in claim 9, in which a desired bending point (27) is formed in the area of the loop apex (26) of the bimetallic strip mount (4).

11. The adjustment apparatus as claimed in claim 2, in which the distance (A) can be adjusted by automatic deformation of the handling limb (4a) and/or of the holding limb (4b) of the bimetallic strip mount (4).

12. The adjustment apparatus as claimed in claim 2 or 11, in which the distance (A) can be adjusted by bending of the handling limb (4a) and/or of the holding limb (4b) of the bimetallic strip mount (4) as a result of housing shrinkage, at bending points and/or kinking/bending points (8 and 19′, 19″, respectively) which can be predetermined.

13. The adjustment apparatus as claimed in claim 12, in which, the bending is produced by housing shrinkage and by the approximation, which results from this, of the housing contours which act as an adjustment contour and in which and/or on which the bimetallic strip mount (4) partially rests.

14. The adjustment apparatus as claimed in one of claims 2 to 7, in which a hole/stamped-out region (29) is arranged at at least one position of the bimetallic strip mount (4), in particular in the area of the holding limb (4b) which is in the form of a step, in order to form
a bending point and/or a kinking/bending point (8 or 19′, 19″, respectively).

15. The adjustment apparatus as claimed in claim 1, in which the switching device (1) has a housing (2) composed of urea and/or melamine resin molding compound.

16. A switching device, in particular a line circuit breaker, having an adjustment apparatus as claimed in one of claims 1 to 15.
